(19) United States
(12) Patent Application Publication
(10) Pub. No.: US 2013/0286318 A1
(43) Pub. Date: Oct. 31, 2013

(54) Liquid Crystal Display and Backframe Structure

(71) Applicant: Yin-Hung Chen, Shenzhen (CN)

(72) Inventor: Yin-Hung Chen, Shenzhen (CN)

(73) Assignee: Shenzhen China Star Optoelectronics Technology Co. Ltd., Guangdong (CN)

(21) Appl. No.: 13/512,346

(22) PCT Filed: May 4, 2012
(86) PCT No.: PCT/CN12/75060

§ 371 Date: May 28, 2012

(30) Foreign Application Priority Data
Apr. 27, 2012 (CN) 201210129130.6

(51) Int. Cl. G02F 1/1333

(52) U.S. Cl. 349/58

(57) ABSTRACT

The present invention provides a liquid crystal display configured with a backframe having an internal surface and external surface. A liquid crystal display panel is installed on the internal surface of the backframe. A printed circuit board is disposed on the external surface of the backframe, the printed circuit board being defined with openings. And wherein the liquid crystal display further includes fixtures located on the backframe, each of the fixture configured with a supporting post and a positioning arm cantilevered from the supporting post, the positioning beam being provided with embossed button, wherein when the printed circuit board is attached to the external surface of the backframe, the printed circuit board is positioned by the fixtures which at least a portion of the embossed button extending into the opening of the printed circuit board. Not only will this ensure a reliable interconnection between the printed circuit board and the backframe, but also will upgrade the performance of assembling the printed circuit board to the backframe.

### FIELD OF THE INVENTION

The present invention relates to a technical field of display and backlight module, and more particularly to a liquid crystal display and a backframe used therein.

### BACKGROUND OF THE INVENTION

Currently, because of its features of slim, compact and light-weighted, the liquid crystal display (LCD) has become the main stream and widely accepted by user. Mostly, it almost completely replace the bulky cathode ray tube which once dominant the market.

An existing LCD generally includes a backframe, a LCD panel, and a printed circuit board. The backframe includes a first surface and a second surface which is covered by metallic sheet. The LCD panel and the printed circuit board are arranged on the first and second surfaces respectively. The printed circuit board is bored with screw holes, and the metallic sheet on the second surface of the backframe is arranged with threaded hole. Eventually, with utilization of screws, the printed circuit board can be readily attached to the backframe.

However, this working process is laborious and the performance is poor as well.

Accordingly, there is a need to provide a novel LCD and its backframe so as to resolve the issue.

### SUMMARY OF THE INVENTION

It is an objective of this invention to provide a LCD and its backframe in which a printed circuit board can be readily assembled onto the backframe.

In order to resolve the technical issue encountered by prior art, the present invention provides a liquid crystal display configured with a backframe having an internal surface and external surface. A liquid crystal display panel is installed on the internal surface of the backframe. A printed circuit board is disposed on the external surface of the backframe, the printed circuit board being defined with openings. Wherein the liquid crystal display further includes fixtures located on the backframe, each of the fixture configured with a supporting post and a positioning arm cantilevered from the supporting post, the positioning beam being provided with embossed button, wherein when the printed circuit board is attached to the external surface of the backframe, the printed circuit board is positioned by the fixtures which at least a portion of the embossed button extending into the opening of the printed circuit board. And wherein the backframe and fixtures are made from conductive material and the printed circuit board provides a conductive surface around the opening.

Wherein the backframe and the fixtures are integrally formed with the back frame.

Wherein the opening on the printed circuit board is a threaded hole, and the embossed button has a dome shape which has a diameter larger than the diameter of the threaded hole.

Wherein an angle between the supporting post and the positioning arm is smaller than ninety (90) degrees.

In order to resolve the technical issue encountered by prior art, the present invention provides a liquid crystal display configured with a backframe having an internal surface and external surface. A liquid crystal display panel is installed on the internal surface of the backframe. A printed circuit board is disposed on the external surface of the backframe, the printed circuit board being defined with openings. And wherein the liquid crystal display further includes fixtures located on the backframe, each of the fixture configured with a supporting post and a positioning arm cantilevered from the supporting post, the positioning beam being provided with embossed button, wherein when the printed circuit board is attached to the external surface of the backframe, the printed circuit board is positioned by the fixtures which at least a portion of the embossed button extending into the opening of the printed circuit board.

Wherein the backframe and fixtures are made from conductive material, and the printed circuit board provides a conductive surface around the opening.

Wherein the backframe and the fixtures are integrally formed with the backframe.

Wherein the opening on the printed circuit board is a threaded hole, and the embossed button has a dome shape which has a diameter larger than the diameter of the threaded hole.

Wherein the supporting post and the positioning arm are perpendicular to each other.

Wherein an angle between the supporting post and the positioning arm is smaller than ninety (90) degrees.

In order to resolve the technical issue encountered by prior art, the present invention provides a liquid crystal display configured with a backframe having an internal surface and external surface. A printed circuit board is disposed on the external surface of the backframe, the printed circuit board being defined with openings. And wherein the liquid crystal display further includes fixtures located on the backframe, each of the fixture configured with a supporting post and a positioning arm cantilevered from the supporting post, the positioning beam being provided with embossed button, wherein when the printed circuit board is attached to the external surface of the backframe, the printed circuit board is positioned by the fixtures which at least a portion of the embossed button extending into the opening of the printed circuit board.

Wherein the backframe and fixtures are made from conductive material, and the printed circuit board provides a conductive surface around the opening.

Wherein the backframe and the fixtures are integrally formed with the backframe.

Wherein the opening on the printed circuit board is a threaded hole, and the embossed button has a dome shape which has a diameter larger than the diameter of the threaded hole.

The present invention can be concluded with the following advantages. The fixtures arranged along peripheral of the backframe can readily and conveniently secure the printed circuit board thereto with the embossed buttons partially extending into the openings of the printed circuit board. Not only will this ensure a reliable interconnection between the printed circuit board and the backframe, but also will upgrade the performance of assembling the printed circuit board to the backframe.

### BRIEF DESCRIPTION OF DRAWINGS

FIG. 1 is a side elevational view of a LCD made in accordance with the present invention and with a printed circuit board attached thereto;

FIG. 2 is a top view of the printed circuit board;

FIG. 3 is a side elevational view similar to FIG. 1, but with the printed circuit board removed;

FIG. 4 is a top view of a the backframe made in accordance with a first embodiment of the present invention; and

FIG. 5 is a top view of the back frame made in accordance with a second embodiment of the present invention.

### DETAILED DESCRIPTION OF PREFERRED EMBODIMENT

Detailed description will be given with the accompanied drawings.

Referring to FIG. 1, the liquid crystal display 100 generally includes a backframe 1 having an internal surface and an external surface. A liquid crystal display panel 2 is attached to the internal surface of the backframe 1. A printed circuit board 3 is disposed on the external surface of the backframe 1 which is integrally formed with fixtures 4.

The printed circuit board 3 is defined with openings 31, and the fixtures are disposed on the backframe 1 to securely position the printed circuit board 3 thereto. Each fixture 4 includes a supporting post 41 rooted on the backframe 1, and a positioning arm 42 cantilevered from the supporting post 41. The positioning arm 42 is provided with embossed button 43. Once the printed circuit board 3 is disposed onto the backframe 1, the embossed button 43 will partially extend into the opening 31 so as to securely the printed circuit board 3 with the backframe 1.

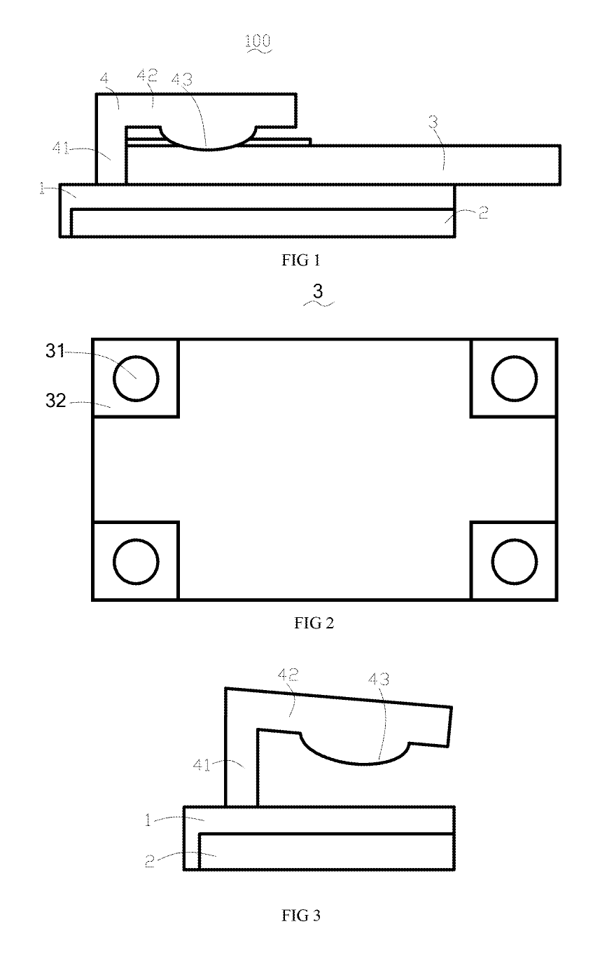

Referring to FIG. 2, the opening 31 defined on the printed circuit board 3 could be a through hole or a blind hole. The cross sectional view of the opening 31 could be a circular shape, an oval shape, or a polygonal shape. There is no limitation on this as long as it can surface its intended purpose. On the other hand, since in the current practice, the printed circuit board 3 is defined with threaded hole as it is bolted to the backframe 1, accordingly, the opening 31 can be embodied as a threaded hole as prior art practice. By this arrangement, no additional work is needed and the cost is reduced as well. It should be noted that no limitations should be imposed to the opening 31.

The printed circuit board 3 is provided with a conductive area 32 around the opening 31. The fixture 4 can be integrally formed with the backframe or selectively assembled thereto by proper means. Preferably, the fixture 4 is integrally formed with the backframe 1 and both are made from conductive material. Once the printed circuit board 3 is assembled to the backframe 1, the positioning arm 42 is electrically interconnecting with the conductive area 32 so as to provide a ground path to the printed circuit board 3.

In order to provide a secured coupling between the opening 31 of the printed circuit board 3 and the embossed buttons 43, their contour are specially designed so as to reach a perfect result or engagement. Preferably, the embossed button 43 is configured with a dome or ball shaped when the opening 31 is embodied with threaded hole so as to securely position the printed circuit board 3 to the backframe 1. The dimension of the embossed button 43 is specially selected to be larger than the diameter of the opening 31 such that there is no play encountered between the embossed button 43 and the opening 31.

Referring to FIG. 3, in order to reduce the space occupied by the fixture 4, the supporting post 41 is vertically rooted onto the backframe 1. In order to increase the securing force of the positioning arm 42 to the printed circuit board 3, the positioning arm 42 is tilted down such that an angle between the supporting post 41 and the positioning arm 42 is less than ninety (90) degrees.

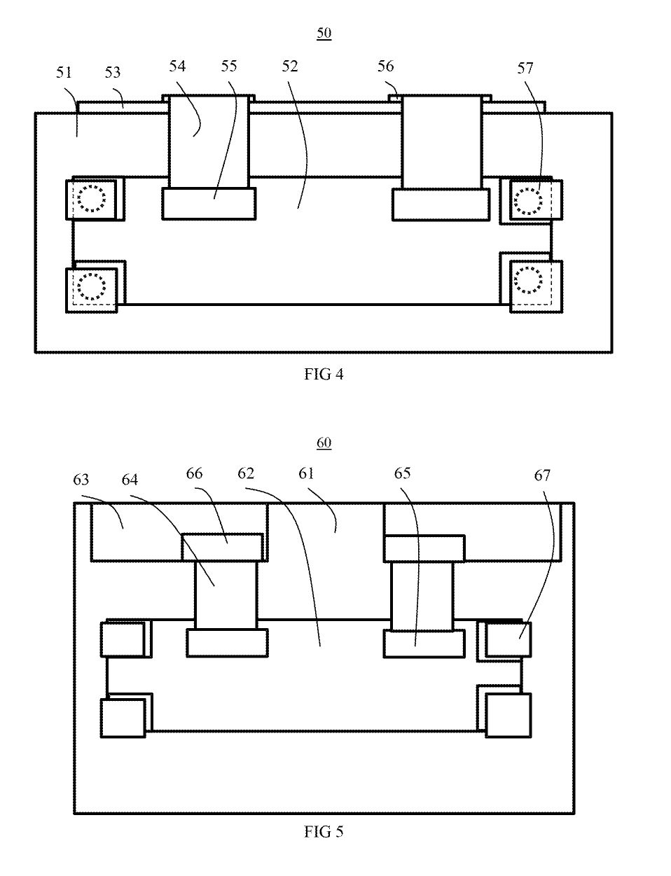

Referring to FIG. 4, a top view of a first embodiment of a backbone device 50 for a liquid crystal display is shown. The backbone device 50 includes a backframe 51, a first printed circuit board 52, a second printed circuit board 53, a flexible printed circuit board 54, a first connector 55 installed on the first printed circuit board 52, and a second connector 56 installed onto the second printed circuit board 53, and a fixture 57.

The first and second printed circuit boards 53 and 54 are assembled to an internal and external surfaces of the backframe 51, and are interconnected together by the flexible printed circuit board 54 coupled between the first and second connectors 55 and 56. The first printed circuit board 53 is securely attached to the backframe 51 by means of fixture 57, while the second printed circuit board 54 is not limited to this arrangement. It can be fixed thereto by means of bolts, or it can also be securely attached thereto by means of fixture 57 such as the first printed circuit board 52.

The securing and positioning procedures of the fixture has been well described, and therefore no further description is given herebelow.

Alternatively to the first embodiment of the backbone device 50, the first printed circuit board 52 can be secured thereto by means of bolts, and the second printed circuit board 53 is secured by the fixture 57. Alternatively, both the first and second printed circuit boards 51 53 are secured by fixture 57.

Referring to FIG. 5, a top view of a second embodiment of a backbone device 60 for a liquid crystal display is shown. The backbone device 60 includes a backframe 61, a first printed circuit board 62, a second printed circuit board 63, a flexible printed circuit board 64, a first connector 65 installed on the first printed circuit board 62, and a second connector 66 installed onto the second printed circuit board 63, and a fixture 67.

The difference between the backbone device 50 and the backbone device 61 is that the first and second printed circuit boards 62, 63 are both disposed on the external surface of the backframe 1, and are interconnected by the first and second connectors 65, 66 along with the flexible printed circuit board 64. The attachment of the first and second printed circuit boards 62. 63 to the backframe 61 is similar to the attachment of the first and second printed circuit boards 52, 53 to the backframe 51 of the backbone device 50. Accordingly, no further description is given here below.

In actual implementation, the printed circuit board can be attached to the backframe by all kind of available positions, and will not be limited to what disclosed above. As it is apparent to the skilled in the art, and not further description is given.

The present invention can be concluded with the following advantages. The fixtures arranged along peripheral of the backframe can readily and conveniently secure the printed circuit board thereto with the embossed buttons partially extending into the openings of the printed circuit board. Not only will this ensure a reliable interconnection between the printed circuit board and the backframe, but also will upgrade the performance of assembling the printed circuit board to the backframe.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A liquid crystal display, comprising:
a backframe having an internal surface and external surface;
a liquid crystal display panel installed on the internal surface of the backframe;
a printed circuit board disposed on the external surface of the backframe, the printed circuit board being defined with openings;
wherein the liquid crystal display further includes fixtures located on the backframe, each of the fixture configured with a supporting post and a positioning arm cantilevered from the supporting post, the positioning beam being provided with embossed button, wherein when the printed circuit board is attached to the external surface of the backframe, the printed circuit board is positioned by the fixtures which at least a portion of the embossed button extending into the opening of the printed circuit board; and
wherein the backframe and fixtures are made from conductive material and the printed circuit board provides a conductive surface around the opening.

2. The liquid crystal display as recited in claim 1, wherein the backframe and the fixtures are integrally formed with the backframe.

3. The liquid crystal display as recited in claim 1, wherein the opening on the printed circuit board is a threaded hole, and the embossed button has a dome shape which has a diameter larger than the diameter of the threaded hole.

4. The liquid crystal display as recited in claim 1, wherein an angle between the supporting post and the positioning arm is smaller than ninety (90) degrees.

5. A liquid crystal display, comprising:
a backframe having an internal surface and external surface;
a liquid crystal display panel installed on the internal surface of the backframe;
a printed circuit board disposed on the external surface of the backframe, the printed circuit board being defined with openings; and
wherein the liquid crystal display further includes fixtures located on the backframe, each of the fixture configured with a supporting post and a positioning arm cantilevered from the supporting post, the positioning beam being provided with embossed button, wherein when the printed circuit board is attached to the external surface of the backframe, the printed circuit board is positioned by the fixtures which at least a portion of the embossed button extending into the opening of the printed circuit board.

6. The liquid crystal display as recited in claim 5, wherein the backframe and fixtures are made from conductive material and the printed circuit board provides a conductive surface around the opening.

7. The liquid crystal display as recited in claim 6, wherein the fixtures are integrally formed with the backframe.

8. The liquid crystal display as recited in claim 5, wherein the opening on the printed circuit board is a threaded hole, and the embossed button has a dome shape which has a diameter larger than the diameter of the threaded hole.

9. The liquid crystal display as recited in claim 5, wherein the supporting post and the positioning arm are perpendicular to each other.

10. The liquid crystal display as recited in claim 9, wherein an angle between the supporting post and the positioning arm is smaller than ninety (90) degrees.

11. A backframe, comprising:
a backframe having an internal surface and external surface;
a printed circuit board disposed on the external surface of the backframe, the printed circuit board being defined with openings; and
wherein the liquid crystal display further includes fixtures located on the backframe, each of the fixture configured with a supporting post and a positioning arm cantilevered from the supporting post, the positioning beam being provided with embossed button, wherein when the printed circuit board is attached to the external surface of the backframe, the printed circuit board is positioned by the fixtures which at least a portion of the embossed button extending into the opening of the printed circuit board.

12. The liquid crystal display as recited in claim 11, wherein the backframe and fixtures are made from conductive material and the printed circuit board provides a conductive surface around the opening.

13. The backframe as recited in claim 12, wherein the fixtures are integrally formed with the backframe.

14. The backframe as recited in claim 11, wherein the opening on the printed circuit board is a threaded hole, and the embossed button has a dome shape which has a diameter larger than the diameter of the threaded hole.
